(19) United States
(12) Patent Application Publication
(10) Pub. No.: US 2016/0109593 A1
(43) Pub. Date: Apr. 21, 2016

(54) METHODS AND SYSTEMS FOR GENERATING PERCOLATED ROCK PHYSICS MODELS FOR PREDICTING PERMEABILITY AND PETROPHYSICAL QUANTITIES

(71) Applicant: Vimal SAXENA, Singapore (SG)

(72) Inventor: Vimal SAXENA, Singapore (SG)

(21) Appl. No.: 14/722,430

(22) Filed: May 27, 2015

Related U.S. Application Data
(60) Provisional application No. 62/065,326, filed on Oct. 17, 2014.

(51) Int. Cl. G01V 1/30; G01V 99/00; G06F 17/16; G01V 1/28

(52) U.S. Cl. CPC G01V 1/303; G01V 1/282; G01V 99/005; G06F 17/16

(57) ABSTRACT

The disclosure relates to a computer-implemented method of generating a percolated rock physics model with interacting pore scheme. Input data relating to observed porosity values, corresponding observed shear velocity or compressional velocity values, and relative proportions of mineral components of a composite matrix comprising a host material, are obtained. The method comprises, for each combination of observed porosity and observed shear velocity or compressional velocity, iteratively: incrementing a pore aspect ratio; determining an initial dry frame compressional modulus and an initial dry frame shear modulus using the observed porosity, the observed velocity and the pore aspect ratio; modifying the initial dry frame compressional modulus using a compressional percolation function and modifying the initial dry frame shear modulus using a shear percolation function; computing a shear velocity or a compressional velocity from the modified shear modulus or the modified compressional modulus; and continuing to iterate until the computed shear velocity matches the observed shear velocity (within a predefined error), or the computed compressional velocity matches the observed compressional velocity (within a predefined error). The method may comprise determining a permeability value through specific pore surface area during each iteration over the pore aspect ratio and pore connectivity. Respective modified compressional modulus, modified shear modulus, permeability and pore aspect ratio values after a last one of said iterations represent mappings from porosity and velocity to wet and dry compressional modulus, shear modulus, permeability and pore aspect ratio in the rock physics model.

### TECHNICAL FIELD

The present invention relates generally to the petrophysical domain of hydrocarbon exploration, i.e. characterization of reservoirs for accumulations of oil or gas. More particularly, embodiments of the invention relate to rock physics modelling of subsurface rock properties, and to methods and systems for predicting acoustic properties and permeability of a reservoir through an integrated rock physics model that utilizes well log and/or core data and links acoustics with rock permeability.

### BACKGROUND

Elastic properties and permeability are among the most valuable geophysical information that the oil industry has been using to characterize the earth's subsurface in exploration and development. Elastic properties are characterized through rock physics models in which acoustic velocities are used as inputs. Rock permeability is modelled through independent petrophysical methods which make use of well log data and/or core analysis data. The permeability relates to the ease with which fluid will flow through the rock, thus directly characterizing the hydrocarbon production capability in an oil and gas reservoir.

The acoustic properties and permeability properties of rock are typically considered to be independent of each other. At non-seismic high frequencies the change in acoustic velocity (dispersion) and acoustic attenuation are modeled in literature where permeability plays a key role (Biot 1956, Geertsma et al. 1961, Stoll 1977). Some indirect correlations are also seen between permeability and acoustic velocities (Klimentos 1991, Best et al. 1994, Alam et al. 2011). However, no current theoretical model is present to predict permeability through rock physics. Other than through dispersion, no modelling connection has previously been theoretically established between acoustic velocities and permeability.

Rocks are generally considered to be a composite of different types of minerals, with fluids being contained in the pore spaces. Rock physics modeling serves a critical role in providing a crucial link between seismic properties (e.g., P & S-wave velocities, attenuation and frequency content), petrophysical properties (e.g., porosity, clay, hydrocarbon saturation, etc.) and the microscopic rock properties (pore geometry, pore connectivity, constituent grains etc.). Interactions in the microscopic domain ultimately leave imprints on petrophysical character and macroscopic seismic responses. Empirical rock physics models are widely used in the oil and gas industry due to their simplicity. These empirical models typically assume simple relationships between P-Wave (or S-Wave) velocity and petrophysical properties. Empirical or semi-empirical models lack accuracy and uniform applicability, and do not involve the role of microscopic phenomena.

Various theoretical models have been proposed for rock physics modeling. Differential effective medium (DEM) theories are most commonly adopted to link acoustic behavior and petrophysical properties through some microscopic character definitions. DEM is explained by Norris (A differential scheme for the effective moduli of composites, 1985), and Berryman et al. (A differential scheme for elastic properties of rocks with dry and saturated cracks, 2002). DEM takes the point of view that a composite material may be constructed by making infinitesimal changes in an already existing composite. The theory models a two-phase composite by incrementally adding inclusions of one phase to a background host matrix of the other and then re-computing the new effective background material at each increment. The host rock matrix properties are determined through rock physics mixture theories and relative constituents of different minerals (sand-clay-carbonate etc.) present in the rock. The scheme involves a definite micro geometry that links the composite rock, petrophysical character and elastic behavior. Micro-pore information and its structural distribution is characterized by pore aspect ratio. The final rock property depends upon micro-pore information defined by aspect-ratio of inclusions, density of inclusions (characterized by porosity) and properties of the host matrix (characterized by composite components). At low frequencies, the model predicts rock elastic moduli and can also predict fluid-wet compressional velocities, when combined with Gassmann's fluid substitution modeling (Gassmann, F., 1951). The DEM model often gets complicated when the microstructure is constituted by different independent domains, like clay and sand in shaly sand, or different porosity types in carbonates. Such schemes are handled by more than one aspect ratio those necessitate multiple assumptions (Zhang et al., 2000, Xu-White 1995, Baechle, 2007).

Other than the assumption of multiple aspect ratios, a big limitation of DEM theory is the basic postulate that considers inclusions as a non-interacting phase. As a result, the final percolation is obtained only at zero solid phase. For any given aspect ratio and porosity, the model overestimates the elastic behavior, as it does not incorporate the pore interaction, connectivity and percolation processes that lead to the practical critical porosity at which the solid phase becomes a pack of loose grains, barely touching each other. As the host and inclusion phase constituents are not treated symmetrically, effective rock properties are also dependent on the construction path (i.e., they are dependent on which material is chosen as the host to incorporate inclusions of the other materials). To incorporate critical porosity a reverse inclusion path has previously been proposed, wherein solid phase gradually replaces a rock with critical porosity phase (Mukerji et al., Differential Effective Medium Modeling of Rock Elastic Moduli with Critical Porosity Constraints, 1995). A more complicated dual-inclusion scheme has also been proposed wherein host rock is incrementally replaced by pore phase and elastic solid phase and host phase becomes zero at critical porosity (Markov M. et al., Novel approach for simulating the elastic properties of porous rocks including the critical porosity phenomena, 2013).

Another implication of non-interacting pore regime in DEM workflow is its limitation to high to very high frequencies (MHz to GHz). At such high frequencies the effect of pore interaction is minimized and the normal DEM workflow simulates the high frequency rock elastic properties.

It is important to realize that none of these rock physics models incorporate permeability, and do not allow a permeability prediction. Currently known rock physics models require input of compressional and shear velocities. Many times only one velocity (most commonly compressional velocity) is available and the other velocity is obtained through data fitting solutions, or various empirically derived relations.

In summary, present approaches for rock physics modeling to simulate acoustic behavior are either semi-empirical in nature, or derived from theoretical models such as DEM which is inconsistent with the fundamental behavior of pore interaction in the poro-elastic system at low (seismic; 10-10² Hz) to medium (logging; kHz) and generally does not honor the concept of critical porosity. The assumption of more than one aspect ratio and modified versions makes the modelling complex, and is subjected to additional assumptions. Above all, none of these models provide a direct link between rock permeability and acoustic properties.

There is a need for a method for use in hydrocarbon exploration that can map reservoir permeability using seismic and well log data. The method should also recognize the fundamental pore-interaction and percolation processes. The method should preferably be accurate and efficient enough to be applied to well log analysis and/or seismic inversion with minimum assumptions and also in the absence of one of the velocities (P-wave, S-Wave). It should also provide the accurate P-to-S (compressional to shear) and S-to-P (shear to compressional) velocity prediction to fill the need of missing velocities.

It would be desirable to provide a way to generate a rock physics model, and to apply it to predict petrophysical parameters, which addresses the above need.

### SUMMARY

In general terms, the present invention relates to a method for generating quantitative permeability from rock properties inverted from seismic/log velocity data. The method may utilize well log data to constrain a rock physics model that relates rock properties to seismic/log and permeability response. The method may also comprise inversion of one seismic/log velocity to the other (P-wave to S-wave and vice versa). The method can in principle be applied to any type of formation, and in particular can be applied to any siliciclastic rock.

In particular, the method may apply a modified version of a forward inclusion DEM model in which infinitesimal pore inclusions incrementally replace the host solid matrix until a desired final porosity is reached. In at least some embodiments, pore interaction and connectivity are characterized by a gradual percolation scheme that weakens the rock frame network on porosity inclusion and pore interaction. This additional weakening is an effect of creating percolation paths in the process of gradual pore inclusions. This percolation effect is governed by a porosity dependent function that has a ‘percolation threshold’ to trigger the weakening of shear and compressional moduli.

Advantageously, the method does not require any assumptions regarding microstructural aspect ratio. Instead, an effective aspect ratio gets calculated as a natural consequence of the process for generating the rock physics model.

The present invention is based on the realization that gradual pore connectivity, due to inclusion-driven percolation, can serve as the driving force for permeability of the rock. Accordingly, in certain embodiments the method computes the incremental pore specific surface area at each infinitesimal inclusion. The truly ‘connected’ specific surface area for flow properties is governed by a percolation driven ‘connectivity function’. Utilizing the connectivity function, computed specific surface area and porosity, the method may make a quantitative estimate of the permeability.

In a first aspect, the present disclosure relates to a computer-implemented method of generating a percolated rock physics model, the method comprising:
(i) obtaining input data relating to observed porosity values, corresponding observed compressional velocity or shear velocity values, and relative proportions of mineral components of a composite matrix comprising a host material;
(ii) for each combination of observed porosity and observed dry velocity, iteratively, using at least one processor: incrementing a pore aspect ratio; incrementing pore inclusions to the observed porosity; determining an initial dry frame compressional modulus and an initial dry frame shear modulus using the observed porosity; modifying the initial dry frame compressional modulus using a compressional percolation function and modifying the initial dry frame shear modulus using a shear percolation function; computing a velocity from the modified shear modulus or the modified compressional modulus; computing specific surface area and permeability; and continuing to iterate until the computed velocity is greater than or equal to the observed velocity within a predefined error;
whereby respective modified compressional modulus, modified shear modulus and pore aspect ratio values after a last one of said iterations represent mappings from porosity and velocity to compressional modulus, shear modulus, permeability and effective pore aspect ratio in the rock physics model.

In a second aspect, the present disclosure relates to a method of predicting petrophysical parameters from porosity and corresponding shear velocity data or wet compressional velocity data, comprising:
Generating a rock physics model according to the first aspect; and
Mapping the porosity and shear velocity or compressional velocity to one or more of: compressional modulus, shear modulus, effective pore aspect ratio, permeability, wet shear velocity and wet compressional velocity using the rock physics model.

In a third aspect, the present disclosure relates to a system for generating a percolated rock physics model, comprising at least one processor, and a non-transitory computer-readable storage medium having stored thereon a rock physics component which is configured to cause the at least one processor to carry out the method according to the first aspect.

In a fourth aspect, the present disclosure relates to a system for predicting petrophysical quantities from porosity and corresponding shear velocity data or compressional velocity data, comprising at least one processor, and a non-transitory computer-readable storage medium having stored thereon a rock physics component which is configured to cause the at least one processor to carry out the method according to the second aspect.

Some embodiments may relate to a method for generating a rock-physics computational model that simulates the effect of pore interaction in agreement with critical porosity concept, having a pore volume, multi-mineral rock volume, acoustic velocity, said method comprising the following steps:
a) Choosing a matrix mixing model for obtaining composite rock properties
b) Choosing a mathematical form of a rock physics model
c) Adding empty pore volumes into rock to the total pore volume of said model
d) Iteratively compute pore specific surface are and intermediate rock elastic properties
e) Implementing pore interaction and percolation scheme
f) Obtaining permeability and rock elastic properties of percolated porous network
g) Including fluid into pore and determining rock elastic properties at seismic and log frequencies
h) Calibrating the parameters simulating the well log properties and velocities data
i) Completing the inversion process and predicting missing acoustic velocities (if any)
j) Determining rock permeability
k) Determining effective aspect ratio

### BRIEF DESCRIPTION OF THE DRAWINGS

Embodiments of the invention will now be described, by way of non-limiting example only, with reference to the accompanying drawings in which:

FIG. 1 is a graph illustrating the effect of percolation on elastic properties of rock and connectivity of percolation paths, and in particular shows a flow connectivity function and compressional and shear percolation functions used in rock physics model of an embodiment of the invention;

FIG. 2 is a flowchart of a standard DEM modelling process;

FIG. 3 is a flowchart of a modified DEM process for predicting velocities (P-wave to S-wave or S-wave to P-wave) using dry core measurements according to an embodiment;

FIG. 4 is a flowchart of a modified DEM process for predicting velocities and permeability using dry core measurements according to an embodiment;

FIG. 5 is a flowchart of a modified DEM process for predicting velocities and permeability using log shear velocities;

FIG. 6 is a flowchart of a modified DEM process for predicting velocities and permeability using log compressional velocities;

FIG. 7(a) shows scatter plots of predicted compressional velocity (Vpd_predic) and measured compressional velocity (Vpd) from the shaly-sand core data set of Han (1986);

FIG. 7(b) is a scatter plot of predicted vs. measured velocity for the data of FIG. 7(a);

FIG. 7(c) shows prediction errors for individual data points for the data of FIG. 7(a);

FIG. 8(a) shows scatter plots of predicted compressional velocity (Vp-th) and measured compressional velocity (Vp dry) from the Quartz-Feldspar-Mica core data set of Blangy et al. (1993);

FIG. 8(b) shows prediction errors for individual data points for the data of FIG. 8(a);

FIG. 9(a) shows scatter plots of predicted compressional velocity (Vp-th) and measured compressional velocity (Vp) from the sandstone core data set of Gomez et al. (2010);

FIG. 9(b) shows prediction errors for individual data points for the data of FIG. 9(a);

FIG. 10(a) shows scatter plots of predicted compressional velocity and actual compressional velocity from the shaly-sand core data set of Khaksar et al. (1999);

FIG. 10(b) shows prediction errors for individual data points for the data of FIG. 10(a);

FIG. 11(a) shows scatter plots of predicted compressional velocity and actual compressional velocity from the Quartz-Clay-Calcite sandstone core data set of Best et al. (1994);

FIG. 11(b) shows prediction errors for individual data points for the data of FIG. 11(a);

FIG. 12 shows scatter plots of predicted permeability (PERM-th) and measured permeability (PERM (md)) for the sand core data of Khazanehdari et al. (2005);

FIG. 13 shows scatter plots of predicted permeability (Perm-th) and measured permeability (Perm) for the Khaksar et al. (1999) shaly-sand core data;

FIG. 14 shows permeability prediction in cores composed of Quartz-Calcite-Clay lithology (Best et al, 1994);

FIG. 15 shows scatter plots of predicted permeability (Perm-th) and measured permeability (Perm) for the Fontainebleau sand core data set of Gomez et al. (2010);

FIG. 16 shows field example of predicted and actual permeability in a high porosity siliciclastic reservoir having low to very high clay content;

FIG. 17 shows predicted and actual shear velocity and permeability using log data and compressional velocity (Vp) from shaly sand;

FIG. 18(a) shows predicted and actual shear velocity for a shaly sand core data set (Blangy et al., 1993);

FIG. 18(b) shows the prediction error for the data of FIG. 18(a);

FIG. 19(a) shows predicted and actual shear velocity for a shaly sand core data set (Gomez et al., 2010);

FIG. 19(b) shows the prediction error for the data of FIG. 19(a);

FIG. 20(a) shows predicted compressional velocity (from shear velocity), predicted shear velocity (from compressional velocity) and comparisons with measured velocities, predicted permeability and comparison with core calibrated permeability, for shaly sand log data;

FIG. 20(b) shows the error distribution for P-to-S velocity prediction for the well log data of FIG. 20(a);

FIG. 20(c) shows the error distribution for S-to-P velocity prediction for the well log data of FIG. 20(a); and

FIG. 21 shows an exemplary rock physics modelling system.

### DETAILED DESCRIPTION OF EMBODIMENTS

Embodiments of the present invention adopt a forward inclusion DEM model in which infinitesimal pore inclusions incrementally replace the host solid matrix until the desired final porosity is reached. Assumptions regarding microstructural aspect ratio are not required. Instead, in the iterative process of simulating true rock properties, the model computes an ‘effective aspect ratio’.

Well log/core petrophysical data are used as input. The processes and systems of embodiments of the invention generate a model of the rock elastic properties, bring pore interaction and percolation into play, and in certain embodiments, also predict permeability. As a result the generated model can be used for prediction of P/S-wave dry/wet velocities at seismic/logging frequencies, and the process can generate the microscopic imprint through an effective aspect ratio. In certain embodiments, the basic framework of the model is formed through Differential Effective Medium (DEM) theory and percolation is brought into play through its impact on elastic and flow properties.

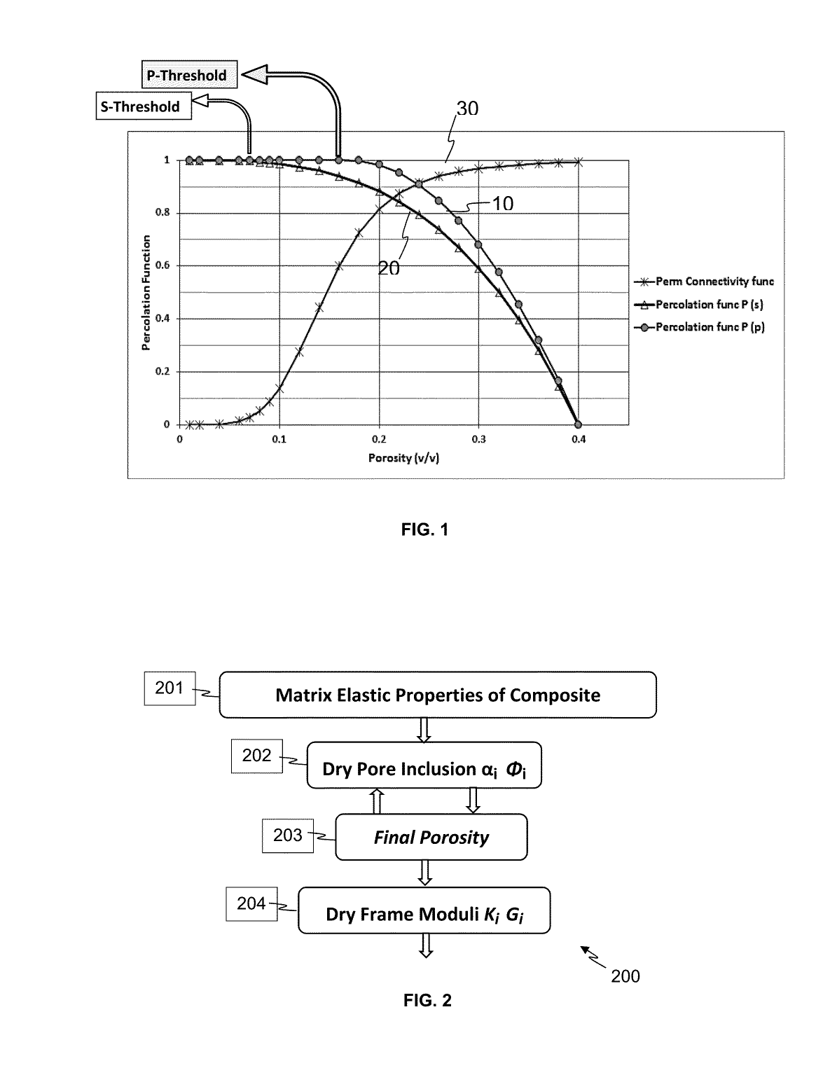

The model accounts for pore interaction and connectivity through a gradual percolation scheme that weakens the rock frame network through pore interaction of inclusion. The percolation is governed by a porosity dependent percolation function that has a percolation threshold to trigger the weakening of shear and compressional moduli. The percolation function is equal to 1 below the percolation threshold porosity, and saturates to zero at the critical porosity. It effectively reduces shear modulus to zero at critical porosity. In preferred embodiments, the percolation paths are slightly different for shear and compressional moduli. Similarly the percolation thresholds may also be different in shaly sands. FIG. 1 shows the percolation functions and percolation thresholds for Shear and Compressional Moduli in shaly sands. Curve 10 is the compressional percolation function, curve 20 is the shear percolation function, and curve 30 is the flow connectivity function (as will be described in more detail below).

The model of embodiments of the invention relies on the realisation that gradual pore connectivity, due to inclusion driven percolation, serves as the driving force for permeability of the rock. The model computes the incremental pore specific surface area at each infinitesimal inclusion. The truly ‘connected’ specific surface area is governed by a percolation driven ‘connectivity function’. Utilizing the connectivity function, computed specific surface area and porosity, the model makes a quantitative estimate of the permeability from a modified form of Kozeny-Carman permeability relation (Latief et al, 2012). FIG. 1 shows the identified general connectivity function 30 due to porous inclusion driven percolation in shaly sands. The function is zero at matrix phase (zero inclusion) and saturates to one at critical porosity, indicating opening of all connection paths for flow and maximum permeability.

The standard DEM model assumes that the rock is composed of two phase materials. The elastic moduli of the starting host material (matrix) are computed through the Hill's average (Hill, 1963) of the Voigt upper bound (isostrain) and the Reuss lower bound (isostress) of a composite matrix formed by more than one component (sand-clay-mica-carbonate etc.). The Voigt-Reuss-Hill (VRH) values for the bulk modulus and the shear modulus of the starting composite matrix are given by:

$$\begin{matrix}Kmat = \frac{1}{2} [ ( {\sum }_{1}^{n} {V}_{i} {Km}_{i} ) + ( 1 / {\sum }_{1}^{n} \frac{{V}_{i}}{{Km}_{i}} ) ] & ( 1 a ) \\ Gmat = \frac{1}{2} [ ( {\sum }_{1}^{n} {V}_{i} {Gm}_{i} ) + ( 1 / {\sum }_{1}^{n} \frac{{V}_{i}}{{Gm}_{i}} ) ] , & ( 1 b )\end{matrix}$$

where Kmat is the starting bulk modulus, Gmat is the starting shear modulus, Vᵢ is the volume fraction of material i, Kmᵢ is the matrix bulk modulus of material i, Gmᵢ is the matrix shear modulus of material i, and n is the number of components of the matrix.

In shaly sand a critical sand porosity can be used (Marion et al., 1992), above which the Reuss lower bound can be preferentially adopted in order to determine the elastic properties Kmat, Gmat of the composite matrix.

The starting phase-1 (matrix) is embedded with dilute concentrations of phase-2 (infinitesimal dry porosity) and new composite properties are computed. In an iterative process, phase-2 material is incrementally re-embedded and composite properties are re-computed. Iteration continues until the phase-1 and phase-2 materials have their desired volume fractions. This allows computation of the end elastic properties. For a homogeneous and isotropic host matrix the general equations governing the change in elastic constant are given by

$$\begin{matrix}( 1 - φ ) \frac{d {K}^{*} ( φ )}{d φ} = [ {K}_{i} - {K}^{*} ( φ ) ] {P}^{*} & ( 2 a ) \\ ( 1 - φ ) \frac{d {G}^{*} ( φ )}{d φ} = [ {G}_{i} - {G}^{*} ( φ ) ] {Q}^{*} & ( 2 b )\end{matrix}$$

K* and G* are bulk and shear moduli of the host phase during inclusion of volume φ. Kᵢ and Gᵢ are the bulk and shear moduli of the inclusion. P* and Q* are polarization constants which depend upon the type of inclusion. Embodiments of the present model utilize the commonly adopted randomly oriented ellipsoidal inclusions for this purpose. However, many other inclusion types are possible (see, for example, Berryman J. G, 1980, Long-wavelength propagation in composite media I. Spherical inclusions and II. Ellipsoidal inclusions, J. Acoust. Soc. America, 68, 1809-1831, the entire contents of which are incorporated herein by reference).

Equations (2a) and (2b) can be solved iteratively by substituting the following expressions for dK* and dG*:

dK*=K−K₁ (3a)

dG*=G−G₁ (3b)

K₁ and G₁ are bulk and shear moduli of the host material. K and G are the bulk and shear moduli of the composite computed in the iterative process after an infinitesimal porosity inclusion dφ in a host frame.

Embodiments of the invention incorporate the pore interaction on dry inclusions of total porosity φ. This can be thought of as development of percolation paths due to pore connectivity and percolation-driven weakening of rock frame moduli through a percolation function. It is recognized that the percolation-enforced weakening of the rock frame involves a ‘percolation threshold porosity’ that triggers the process. The percolation function, starting from value 1 at zero porosity to percolation threshold porosity, saturates to zero at critical porosity. It effectively reduces shear modulus to zero at critical porosity. It has been found from examination of shaly sand data that percolation paths of shear and compressional moduli are different. It has also been found from analysis of shaly sands data that the percolation-threshold is different for shear and compressional moduli. Accordingly, in embodiments of the invention, the percolation function may have a different functional form and/or a different percolation threshold for compressional and shear moduli. FIG. 1 shows an exemplary elastic percolation function and shear and compressional percolation thresholds in siliciclastics. The compressional percolation function P(p) and shear percolation function P(s) may have the following general form:

$$\begin{matrix}P ( s ) = 1 - a ( \frac{φ}{{φ}_{c}} ) [ \frac{exp ( φ / {φ}_{c} ) + exp ( - φ / {φ}_{c} )}{2} - 1 ] & ( 4 a ) \\ P ( p ) = [ 1 - {( \frac{φ - {φ}_{th} ( p )}{{φ}_{c} - {φ}_{th} ( p )} )}^{b} ] & ( 4 b )\end{matrix}$$

where φ_{c} is critical porosity, φₜₕ(p) is the percolation threshold porosity for compressional waves, φₜₕ(s) is the percolation threshold porosity for shear waves, and ‘a’ and ‘b’ are constant. Values for ‘a’ and ‘b’ can be determined using a single training data set (for example, shaly sand data) and can be fixed and used for other data sets with good results, as shown later. For siliciclastics the constant ‘a’ may vary in the range 1.8-2.0 while constant ‘b’. is close to 2.

In the present percolated DEM scheme, the dry frame moduli reduce on porous inclusion due to the percolation process and the final compressional and shear moduli are governed by

Mₚ=MP(p) (5a)

Gₚ=GP(s) (5b)

M is the compressional modulus and is calculated in standard fashion from the bulk modulus and the shear modulus according to M=K+4/3G. Mₚ and Gₚ are percolated compressional and shear moduli. P(p) and P(s) are the respective percolation functions for compressional and shear moduli, for example the percolation functions 10 and 20 shown in FIG. 1. These percolated moduli are utilized as end products for rock properties simulation and effective aspect ratio determination.

The iterative inclusion process can be thought of as creating a percolation path that is characterized by the flow-connectivity of the pore system, which can be represented by an analytical ‘connectivity function’ C(φ):

$$C ( φ ) = [ \frac{1}{1 + c {φ}^{- d}} ] \qquad ( 6 )$$

In Eq. (6), ‘c’ and ‘d’ are constants which can be determined using one data set for a particular composite, and then applied to other data sets/composites. For silicilastics the constant ‘c’ is close to 10⁻⁴ and ‘d’ may vary in the range 4.75-4.9. FIG. 1 shows an exemplary connectivity function determined for porous inclusion driven percolation in shaly sands. The function is zero at matrix phase (zero inclusion) and saturates to 1 at critical porosity, indicating opening of all connection paths and maximum permeability.

The present scheme computes the specific pore surface area of infinitesimal inclusion based on infinitesimal volume (porosity) of inclusion, inclusion geometry and aspect ratio. This gets incremented on each infinitesimal iterative inclusion. Following the final iteration process and on reaching the final porosity, the specific surface area of pore space can be computed as:

Sᵥ_{ₚ}=Σ_{φ=0}^{φ}^{_{obs}}ΔSᵥₚⁱ (7)

ΔSᵥₚⁱ is the infinitesimal increase in specific pore surface area on every infinitesimal porous inclusion and Sᵥₚ is the final specific pore surface area on reaching a desired observed final porosity φ_{obs}. For ellipsoidal inclusion of aspect ratio α and of volume 10⁻⁶ the specific pore surface area (pore surface area per unit pore volume) is calculated as:

$${S}_{vp}^{i} = {( {10}^{- 6} α )}^{2 / 3} {( \frac{9 π}{2} )}^{1 / 3} ( 1 + {Sin}^{- 1} ( \sqrt{1 - {α}^{2}} ) / α \sqrt{1 - {α}^{2}} ) \qquad ( 8 )$$

. Using the percolation connectivity function C(φ), the rock permeability k is estimated by modifying the Kozeny-Carman relation as below:

$$k = ( \frac{1}{2 τ {S}_{vp}^{2}} ) φ = A ( \frac{C ( φ ) {φ}^{p}}{{S}_{vp}^{2}} ) φ \qquad ( 9 )$$

‘A’ is a constant which has been found to lie in the approximate range 20-25 in shaly sands while ‘p’ lies in the range 1.5-2. It is also recognized that for wet shaly-sand log data Φ^{p} needs be replaced by effective porosity function Φe^{p} It may be appreciated that different lithology (like carbonate) may have a modified scheme of ‘connectivity function’ than shown in Equation (6). The present form pertains to siliciclastics. Constants within the connectivity-function can be determined by calibration methods well known in the art.

In general terms, to determine the permeability, the DEM process described above is iteratively performed, iteratively computing specific pore surface area, multiplying the moduli by the respective percolation functions Eq. 4(a) and Eq. 4(b) to obtain the percolated moduli and determine intermediate permeability from Eq. (6) and Eq.(9). Iteration begins with a small value for the aspect ratio, and at each iteration, aspect ratio is incremented and the percolated moduli and permeability are recalculated. A velocity is computed, and compared to the observed (input) velocity. Iteration over the aspect ratio continues until the simulated velocity closely matches the observed rock velocity. Gassmann's relation (1951) is used to derive wet velocities. In the case that shear velocity is used for the simulation, the final results would be compressional dry and wet velocities, effective aspect ratio (i.e., the aspect ratio attained at the point that the iteration terminates) and rock permeability. When dry compressional velocities are used for simulation, the process generates dry and wet velocities, effective aspect ratio and rock permeability. In case of borehole sonic data, on utilizing the wet compressional velocities an additional stage is added in the workflow to implement dispersion correction to the wet compressional velocities at each intermediate stage, utilizing the computed intermediate permeability at that stage. The process may generate shear velocity prediction, permeability prediction and effective aspect ratio determination. In case of wet data or log examples the final velocity prediction may need a uniform minor correction factor close to 1.05 if dispersion correction remains limited to Biot's dispersion (Biot, 1956). More perfect field predictions are achieved by incorporating both Biot and Squirt mechanism BISQ model (Dvorkin et al, 1993). For dry core measurements no such correction is required for velocity prediction.

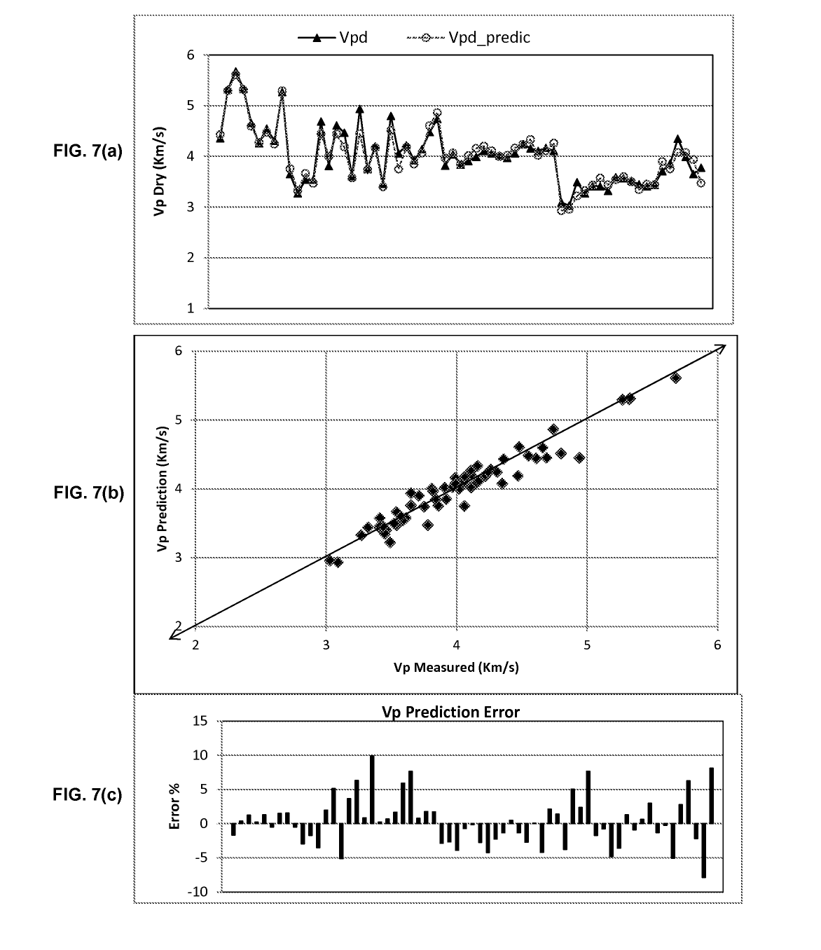

Each of these applications is described in more detail below with reference to FIGS. 2 to 6, and results from testing of the respective processes 200, 300, 400, 500 and 600 on published core data and field sonic data are shown in FIGS. 7 to 20. An exemplary system for implementing the processes 200, 300, 400, 500 and 600 is shown in FIG. 21.

Embodiments of the invention are able to predict permeability, which is not possible with existing rock physics models. Further, aspect ratios are not required as an input parameter to the model, and if only one acoustic velocity (compressional or shear) is available, the model can generate the other. These are possible by virtue of the fact that interacting pores and gradual percolation are introduced within the modelling process.

FIG. 2 is a flowchart describing basic steps in a Differential Effective Medium (DEM) process 200 implemented in embodiments of the invention. In step 201, elastic properties of a matrix are estimated. The matrix is composed of different minerals present in the system. Volumetric components of the individual minerals and their respective matrix moduli are mixed through the V-R-H (Voigt-Reuss-Hill) averaging method as described above. In modelling of shaly-sands a critical sand porosity content is used (Marion et al., 1992), above which Voigt's lower bound can be used to determine elastic properties of the composite matrix. In step 202, dry ellipsoidal inclusions of aspect ratio αᵢ and infinitesimal porosity φᵢ are made and new elastic properties are computed. In step 203, the process (202) of dry inclusions and estimation of new moduli is iterated until the desired final porosity φ is reached. At step 204 the final dry frame elastic moduli Kᵢ and Gᵢ are determined as the respective values after the final iteration, thus completing the DEM process 200.

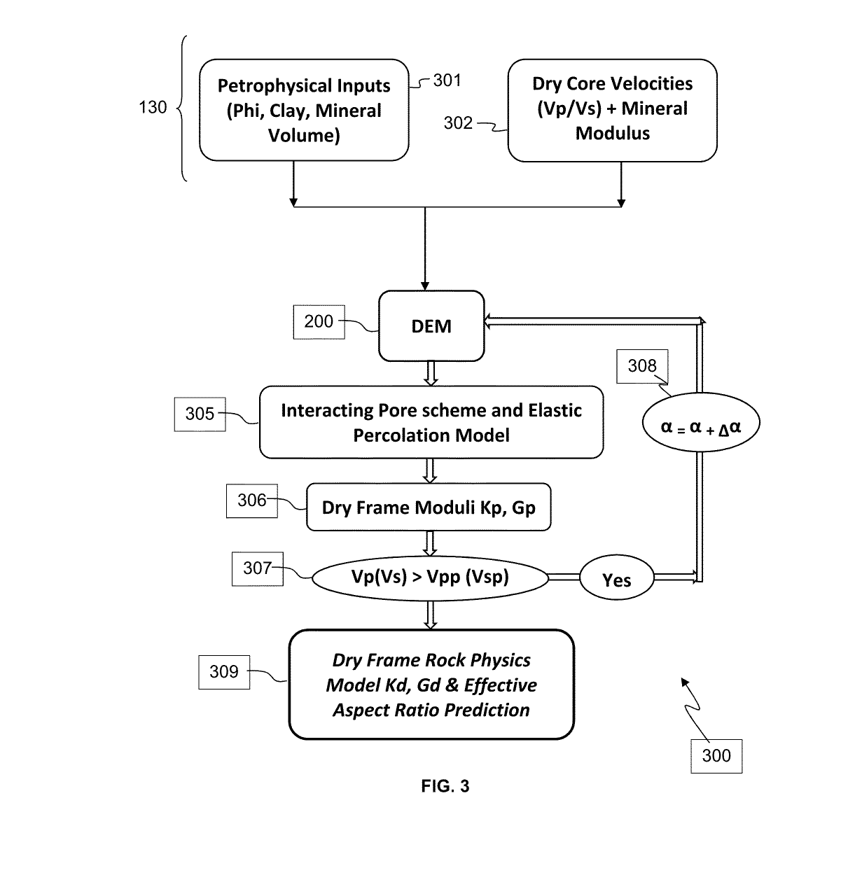

FIG. 3 shows a process 300, implemented by a computer, for generating a rock physics model according to embodiments of the invention. The process 300 incorporates an interacting pore scheme into a DEM process 200, and estimates final dry frame elastic properties and an effective aspect ratio without any assumptions as to aspect ratio, using core measurements.

The process 300 receives input data 130 indicative of observed porosity φ_{obs} and relative mineral volumes of the matrix, at step 301. Further input data indicative of observed dry frame velocities (compressional velocity Vp or shear velocity Vs) from core measurements are received at step 302. Dry core velocities are input in order to avoid dispersed velocities, as core measurements are normally made at ultrasonic frequencies. Step 302 also involves input of mineral modulus data, representing the bulk and shear moduli of the individual components of the matrix. The input data 130 are used to generate the dry frame rock physics model by simulating bulk modulus K_{d} and shear modulus G_{d} for each combination of observed porosity and observed dry frame velocity, in order to computationally determine functions K_{d}(φ, v) and G_{d}(φ, v) which can then be used to predict the moduli for any observed porosity and velocity values φ and v.

In process 300, a DEM modelling process 200 is used. DEM modelling process 200 takes as input the dry frame velocity Vp or Vs and iterates from φ=0 to φ=φ_{obs} (incrementing φ by some small amount on each iteration) to generate, as described above, dry frame moduli Kᵢ and Gᵢ. DEM process 200 is initially carried out with a very low starting aspect ratio αᵢ, and the aspect ratio is gradually increased at each iteration as will now be described.

Once the DEM process 200 is complete, step 305 implements elastic percolation by multiplying the compressional and shear moduli Mᵢ (=Kᵢ+4Gᵢ/3) and Gᵢ by the respective percolation functions 10 and 20 (using the appropriate value of φ, i.e. φ_{obs}) of FIG. 1, and at step 306 percolated elastic bulk and shear moduli Kₚ, Gₚ are obtained.

At step 307, the process 300 computes a percolated shear velocity Vₛₚ from Gₚ, and determines whether the computed shear velocity is less than the input shear velocity Vₛ by more than a predefined small error (for example, 0.01%). If it is, the aspect ratio α is incremented by a small amount Δα at step 308, and the process 300 returns to DEM step 200. Iteration over α continues until the stopping criterion 307 is met, at which point, at step 309, the process 300 returns the final computation of the elastic moduli K_{d} and G_{d} and the effective aspect ratio (i.e., the value reached by α by the time that iteration has stopped). Process 300 is repeated for each combination of input porosity φ and shear velocity Vₛ, such that a model relating K_{d}, G_{d} and effective aspect ratio with input porosity and shear velocity Vₛ is generated. Accordingly, the generated model can be used to predict, given values of φ and Vₛ, the corresponding elastic moduli and aspect ratio. In other embodiments, rather than using the shear velocity Vₛ (for example if this is not available), the compressional velocity Vₚ can be used in same way.

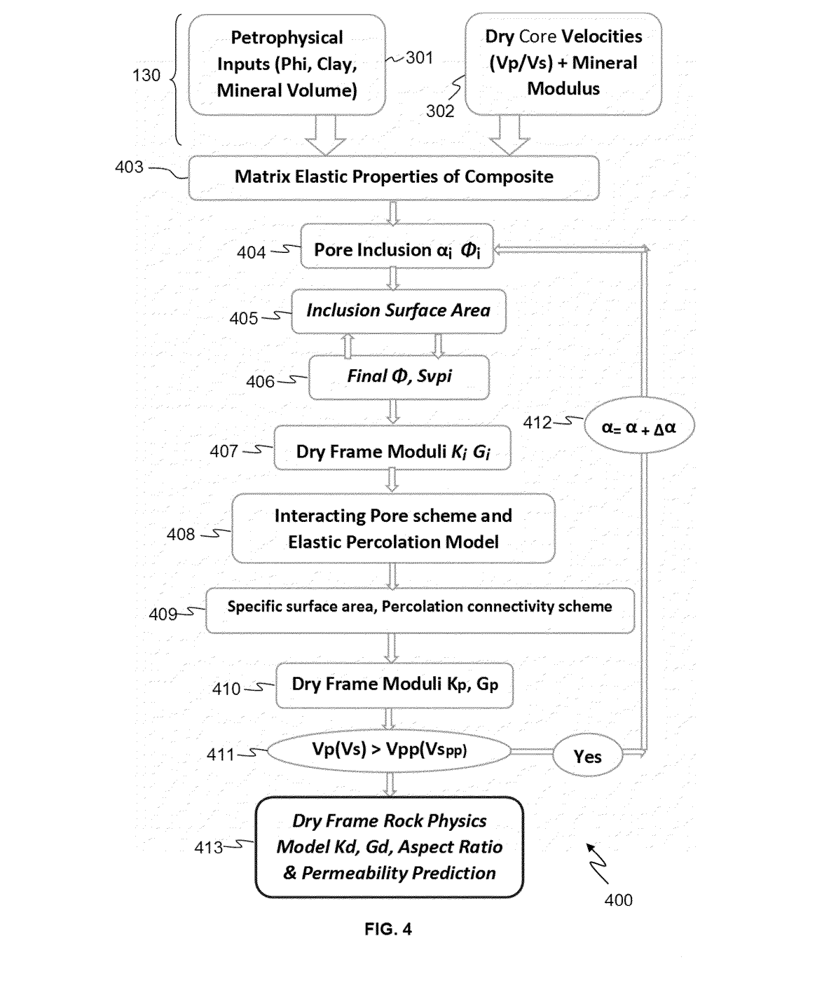

FIG. 4 shows an alternative embodiment in which permeability computation along with the interacting pore scheme is brought into a DEM process. Input data 130 to the process 400 is the same as for process 300. At step 404 infinitesimal inclusions into the matrix and computation of changed moduli are performed, similarly to step 202 of FIG. 2. At step 405 pore specific surface area after inclusion (step 404) of the infinitesimal volume of ellipsoidal pores is computed. At step 406 an iterative process of inclusions is performed, substantially as described above in DEM process 200, until the desired final porosity is reached. The final specific pore surface area Sₚ is computed. At step 407 final dry frame elastic properties Kᵢ and Gᵢ are estimated following the completion of the iterative inclusion process 405, 406. Step 408 is similar to step 305 of FIG. 3, in which the percolated interacting pore scheme is implemented in relation to the elastic properties. In particular, elastic moduli Mᵢ (derived from Kᵢ as described above) and Gᵢ are multiplied by the respective percolation functions 10, 20. At step 409, specific pore area is determined according to Eq. (7), and the intermediate permeability k is computed according to Eq. (8). At step 410 the percolated elastic properties Kₚ, Gₚ are computed as described above.

At step 411, the process 400 computes a shear velocity Vₛₚ from Gₚ, and determines whether the computed shear velocity is less than the input shear velocity Vₛ by more than a small predefined error (for example, more than 0.01%). If it is, the aspect ratio α is incremented by a small amount Δα at step 412, and the process 400 returns to step 404. Iteration over a continues until the stopping criterion 411 is met, at which point, at step 413, the process 400 returns the final computation of the elastic moduli K_{d} and G_{d}, the effective aspect ratio, and the permeability. The process 400 is repeated for each combination of input porosity and shear velocity Vₛ, such that a model relating K_{d}, G_{d}, effective aspect ratio and permeability with input porosity φ and shear velocity Vₛ is generated. Accordingly, the generated model can be used to predict, given values of φ and Vₛ, the corresponding bulk and shear elastic moduli, compressional velocity Vₚ, effective aspect ratio, and permeability. In alternative embodiments, as for the process 300 of FIG. 3, the compressional velocity Vₚ can be used with very similar logic. This will result in predicting shear velocity Vₛ, corresponding bulk and shear elastic moduli, effective aspect ratio, and permeability.

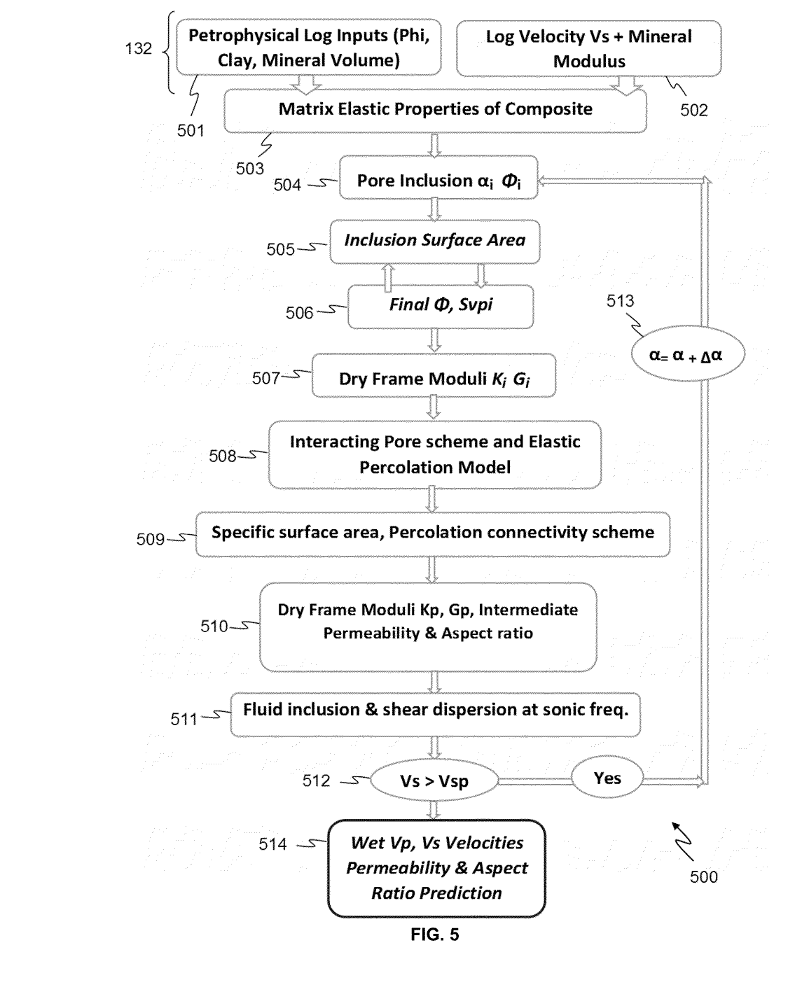

FIG. 5 shows an alternative embodiment of a process 500 for generating a model for permeability, elastic properties and effective aspect ratio using well log data 132 as input. Shear sonic velocity is used as key simulator here. At step 501 petrophysical evaluation is performed to determine relative volumetric estimates of mineral (Quartz-Clay in shaly sand, Quartz-Clay-Carbonate-Mica-Feldspar in complex shaly sand) and porosity from the log data. This is input into process 500. At step 502 sonic velocity input from the log data is received. In particular, wet-shear log velocity is used as input. At step 503 elastic properties of the composite matrix are determined, based on input from step 501, similarly to step 202 of FIG. 2. At step 504 a DEM process is initiated, whereby dry pores of a starting aspect ratio αᵢ and infinitesimal porosity φᵢ are included into the matrix. At step 505 specific pore surface area on the inclusion of infinitesimal pore is estimated. At step 506 iteration over steps 504 and 505 from φ=0 to φ=φ_{obs} is performed, substantially as described above, updating the computation of K, G and Svpi at each iteration. At step 507 intermediate dry elastic properties (Ki, Gi) and specific pore surface area (Svpi) are computed, on completion of the iterative inclusion process 504-506. Next, at step 508, the elastic percolation process is implemented by determining appropriate values of the respective percolation functions at the input porosity value. At step 509 the permeability connectivity concept is implemented, consequent to the interacting pore scheme described above, by determining a value for the connectivity function at the input porosity value. At step 510 the percolated elastic moduli (Kp, Gp) and intermediate permeability are calculated using the determined percolation and connectivity values. At step 511 fluid inclusion is implemented and dispersed shear and compressional velocity as logging frequency (Stoll, 1977 & Geertsma et al, 1961) are computed. This computation utilizes the intermediate permeability computed within the workflow. In some embodiments, this step (511) can be replaced by a simpler Gassmann's fluid substitution to compute the wet sonic compressional velocities. It is found that Gassmann's substitution driven compressional velocities may need a very small correction factor (typically between 1.02 and 1.05) for comparison to sonic wet compressional velocities. At step 512, the computed sonic velocity Vsp is compared with the input sonic velocity Vs. If Vsp is less than Vs (beyond a predefined small error margin, such as 0.01%) the process 500 moves to iterative step 513 with a very small increase Δα in aspect ratio. Otherwise, at step 514, the final permeability, wet and dry compressional velocities, wet and dry elastic moduli, and effective aspect ratio are computed.

The process 500 is repeated for each combination of input porosity φ and log shear velocity Vₛ, such that a model relating dry and wet frame moduli, dry and wet Vₚ and Vₛ, effective aspect ratio and permeability with input porosity φ and shear velocity Vₛ is generated. Accordingly, the generated model can be used to predict the above at each given values of φ and Vₛ on the log.

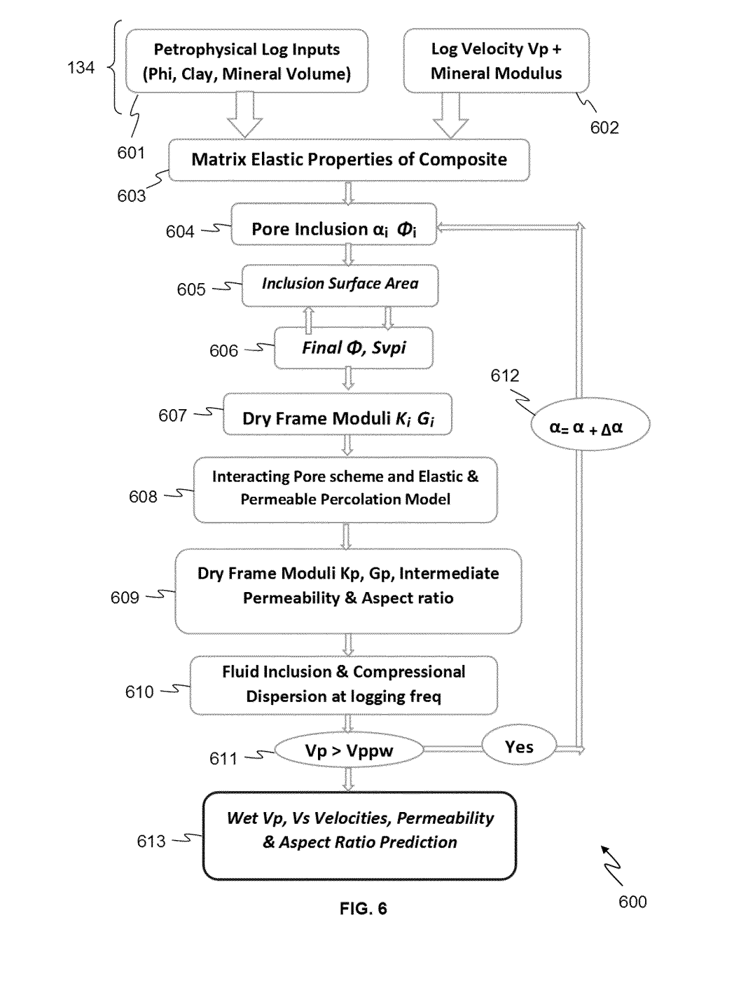

FIG. 6 shows an alternative embodiment of the invention with the most common scenario, where compressional velocity is present from sonic/seismic and shear velocity information is absent. In the process 600 of FIG. 6, permeability, elastic properties and effective aspect ratio are predicted with inputs 134 from well log data. The most commonly available wet-compressional velocity Vp from log/seismic is used as key simulator here.

At step 601, similarly to step 501, petrophysical evaluation is performed to determine relative volumetric estimates of mineral (Quartz-Clay in shaly sand, Quartz-Clay-Carbonate-Mica-Feldspar in complex shaly sand) and porosity from log data. This is input into workflow 600. At step 602 the sonic/seismic velocity (Vp) is received as input from the log data. Steps 603 to 607 are carried out as for step 503 to step 507 of FIG. 5. At step 608 elastic percolation and permeability connectivity process, as a result of interacting pore scheme, are implemented by computing appropriate values for percolation and connectivity at the input (observed) porosity using the functions defined above. At step 609 percolated dry frame elastic moduli (Kp, Gp), intermediate permeability and aspect ratio are computed. At step 610 fluid inclusions is implemented and dispersed wet-compressional and wet-shear velocity as logging frequency (Stoll, 1977 & Geertsma et al, 1961) are computed. This computation utilizes the intermediate permeability computed at step 609. Step 610 has been found to be sensitive to final results and cannot be replaced by a simple Gassmann algorithm. At step 611 computed wet compressional velocities (Vppw) from step 610 is compared with the input sonic compressional velocity (Vp). If Vppw is less than Vp (beyond a predefined very small error margin), the process 600 moves to iterative step 612 with a very small increase Δα in aspect ratio. Otherwise, at step 613, the final permeability, wet compressional and shear velocities, dry and wet elastic moduli, and effective aspect ratio, are computed. Accordingly, the generated model can be used to predict, given values of φ and dry Vₚ, the corresponding dry & wet elastic moduli, wet Vₚ and Vₛ, effective aspect ratio and permeability.

Since each of the processes 300, 400, 500 and 600 iterates over aspect ratio, once the iterative steps are completed, a final aspect ratio is attained. This can be taken as an effective aspect ratio associated with the rock physics model (for each value of input porosity and velocity). Advantageously, therefore, the effective aspect ratio arises as a natural consequence of the processes 300, 400, 500, 600, without requiring any input assumptions.

Embodiments of the present invention thus predict rock permeability while formulating a rock physics model that predicts shear from compressional velocity and similarly predicts compressional from shear velocity. Prediction of dry frame moduli and the microstructural information ‘effective aspect ratio’ that uniquely simulates the rock elastic behaviour is also enabled. Embodiments can be implemented using log or core data as input. In the absence of any sonic log or core velocity data, the process can still be implemented if a representative aspect ratio is known.

Turning now to FIGS. 7 to 20, experimental results validating the processes workflow of FIGS. 2 to 6 are shown using core data and field logs.

FIG. 7 shows validation of the process 300 of FIG. 3. Here dry shear velocities are used to predict compressional dry velocities in shaly sand core samples at 40 MPa overburden pressure (Han, 1986). Samples have varying porosity (0-30%) and varying clay content (0-40%). FIG. 7(b) shows a plot of predicted dry Vp against core measurements that shows the quality of the prediction. FIG. 7(c) shows errors for the 64 samples in the data set. It is seen that prediction works within a typical error range of +/−5%.

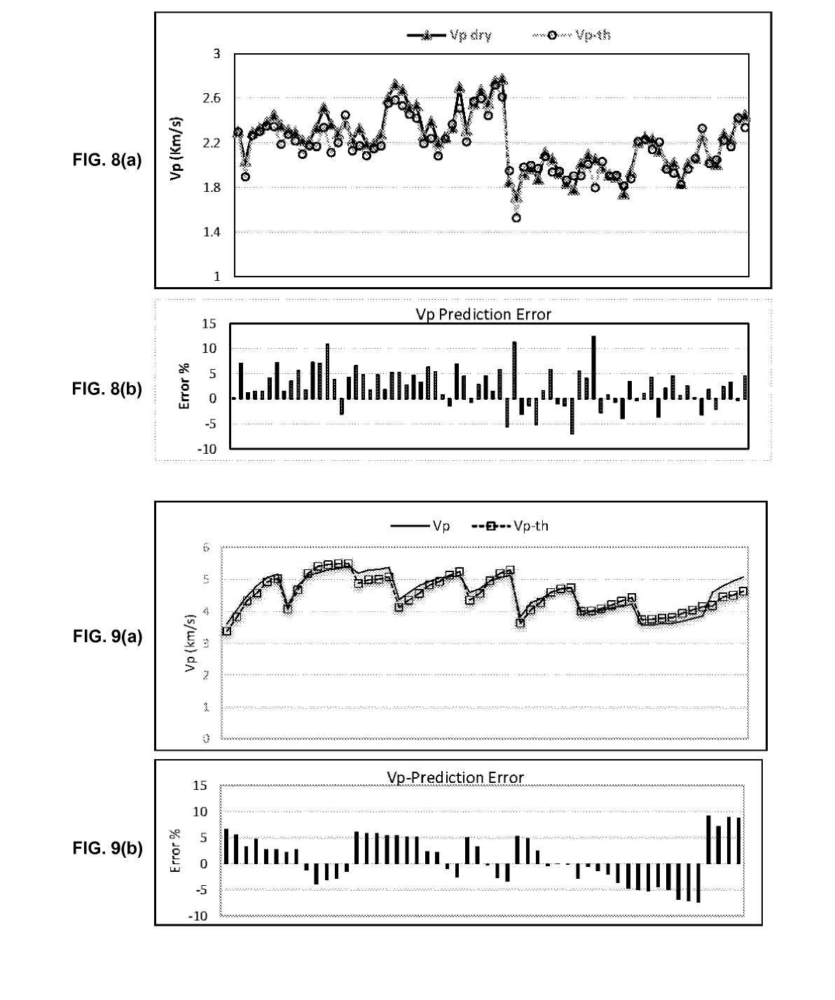

FIG. 8 shows the validation of process 300 in complex lithology shaly sand, composed of Quartz, Feldspar and Mica in varying proportion (Blangy, 1992 and Blangy et al., 1993). The dry shear velocities are used to predict compressional dry velocities. FIG. 8(a) shows closely matching actual and predicted curves and FIG. 8(b) shows the errors in the respective predictions. The prediction uncertainty remains within +/−5%.

FIG. 9 shows similar validation and prediction uncertainty using multi-pressured core data from Fontainebleau sandstones (Gomez, 2010). Computed dry Vp can be predicted with an error within +/−5% uncertainty for samples overburden of 2.5-40 MPa.

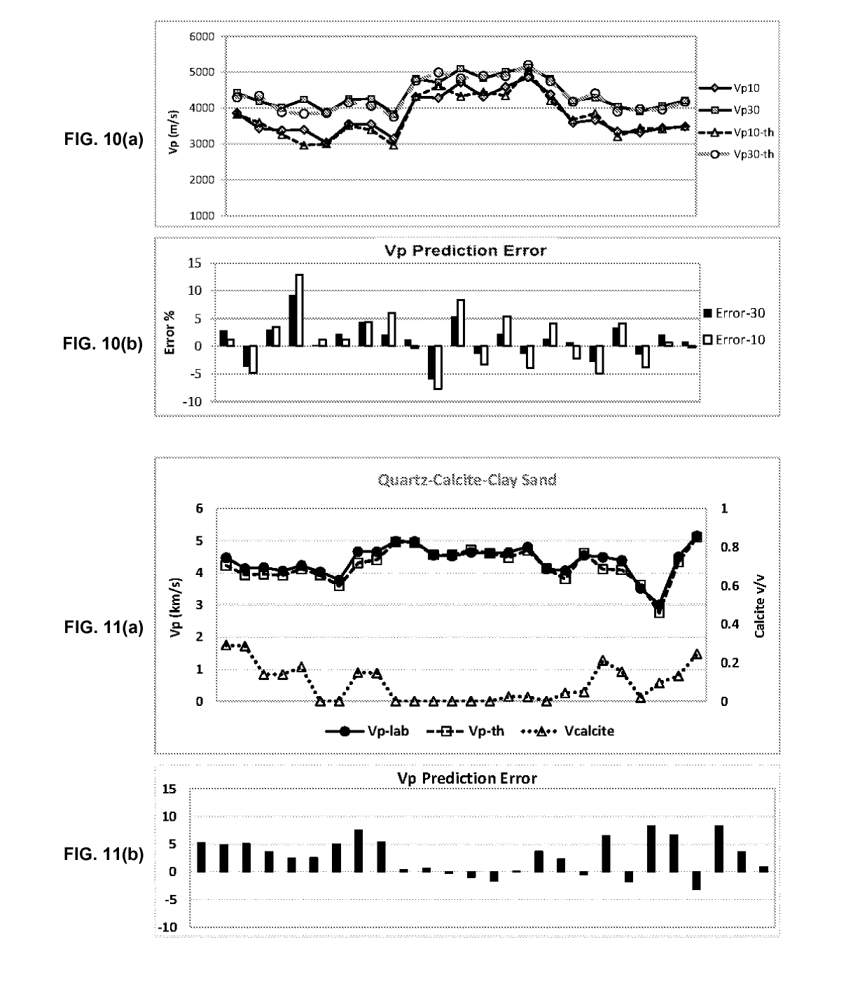

FIG. 10 shows the validation of process 300 in multi-pressured shaly sand core data at 10 MPa and 30 MPa overburden pressure (Khaksar et al., 1999). Dry frame Vp is well predicted within 5% uncertainty.

FIG. 11 shows the results of process 300 for core data composed of Quartz-Calcite-Clay (Best et al., 1994). Calcite content varies as 0-20%. The workflow successfully predicts dry frame compressional velocities within +/−5% uncertainty.

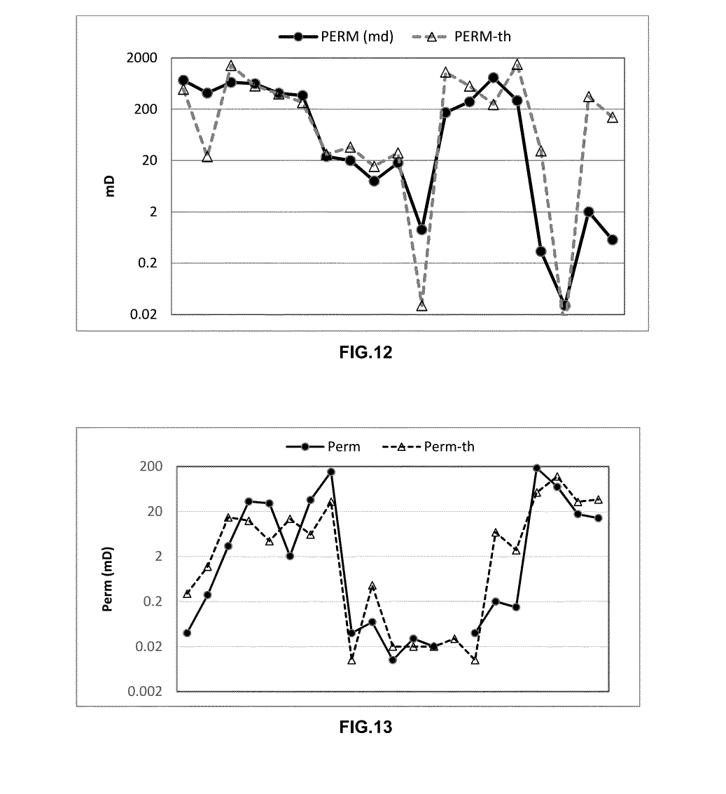

The permeability workflow 400 shown in FIG. 4 was also validated. FIG. 12 shows the permeability prediction from 20 MPa sand core data of 19 samples (Khazanehdari et al., 2005). Predicted permeability shows a good quantitative match with measured core-measured permeability.

FIG. 13 shows the permeability prediction from 10 MPa shaly-sand core data of 21 samples (Khaksar et al., 1999). Predicted permeability from workflow 400 has a good correlation and quantitative match with core-measured permeability.

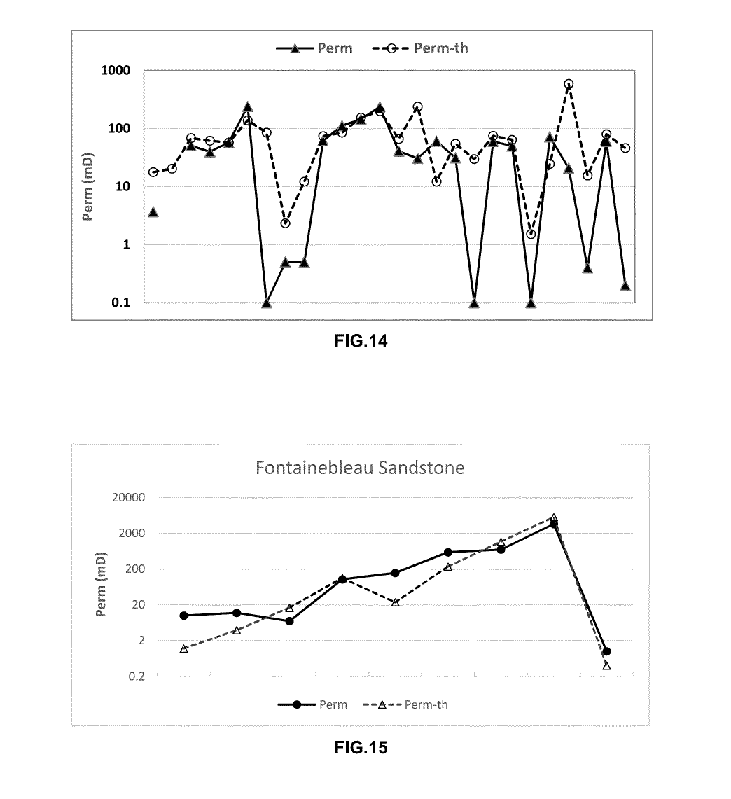

FIG. 14 also shows the permeability prediction in cores composed of Quartz-Calcite-Clay lithology (Best et al, 1994). Model-computed and core-measured permeability show a good correlation and quantitative match.

FIG. 15 shows another example of permeability prediction while using core data from Fontainebleau sand (Gomez, 2010). Model-computed and core-measured permeability show a good correlation and quantitative match.

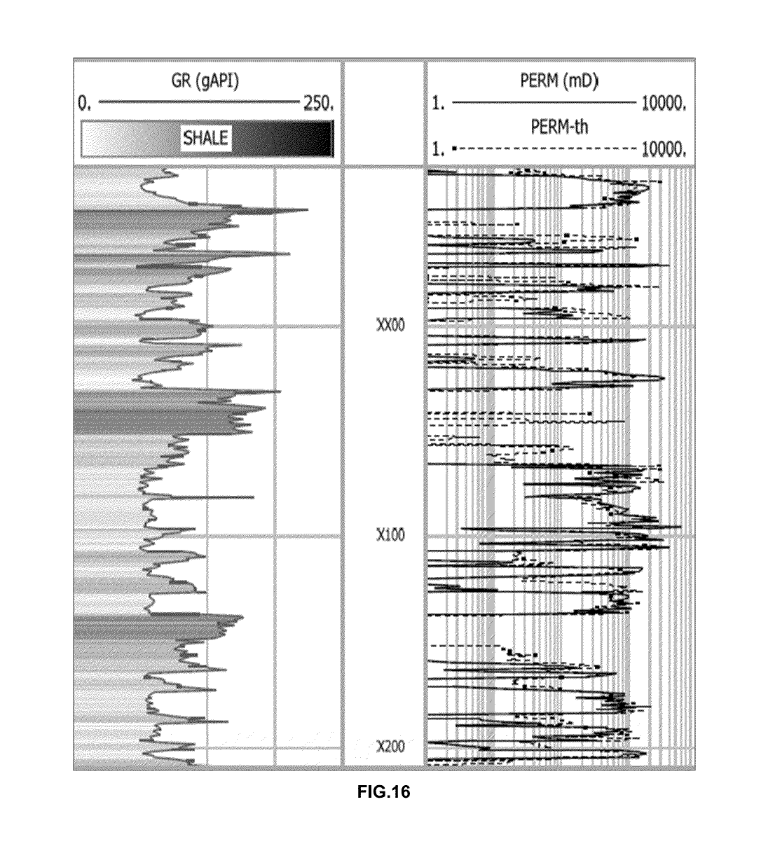

FIG. 16 demonstrates field validation of the permeability prediction workflow 500 shown in FIG. 5. In a high porosity (15-30%) siliciclastic reservoir having low to very high clay (5-50%) content, permeability is predicted in the well. The predicted permeability (PERM-th) is compared with the established permeability log data (Perm (mD)) that is derived through independent core calibration. Predicted permeability log demonstrates an excellent quantitative validation of present invention and percolated Rock Physics model.

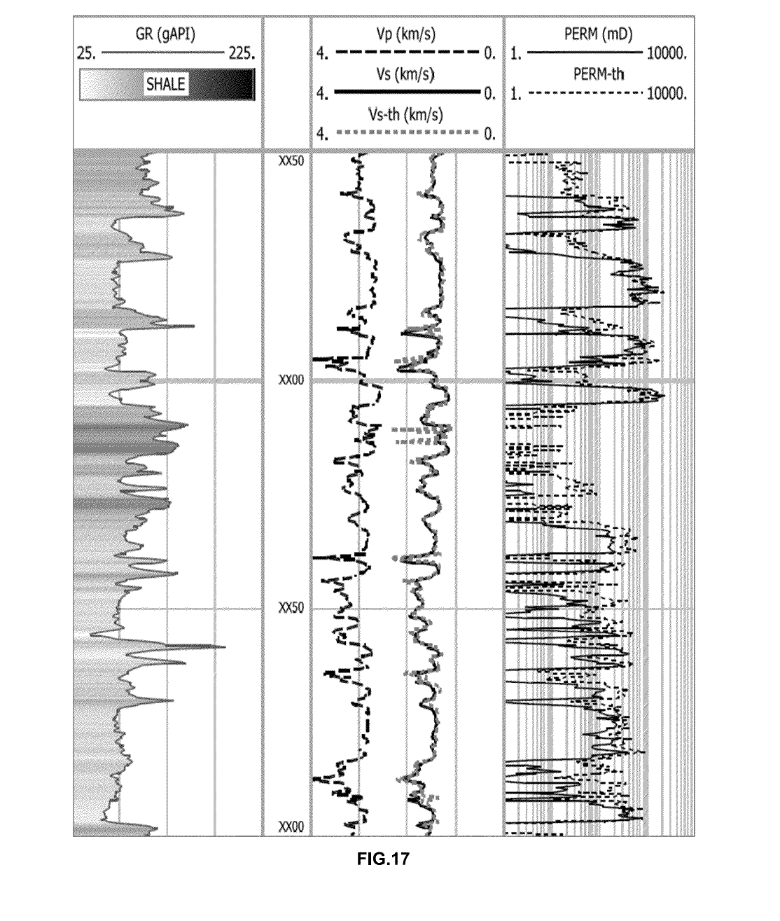

FIG. 17 shows the field validation of workflows 600 shown in FIG. 6 using log data. In shaly sand well wet shear velocities are predicted at logging frequency, using wet compressional velocities from Sonic log. Permeability is also predicted from workflow. Predicted shear velocity closely match with the log data and predicted Permeability quantitatively match with Permeability derived from core calibrated data.

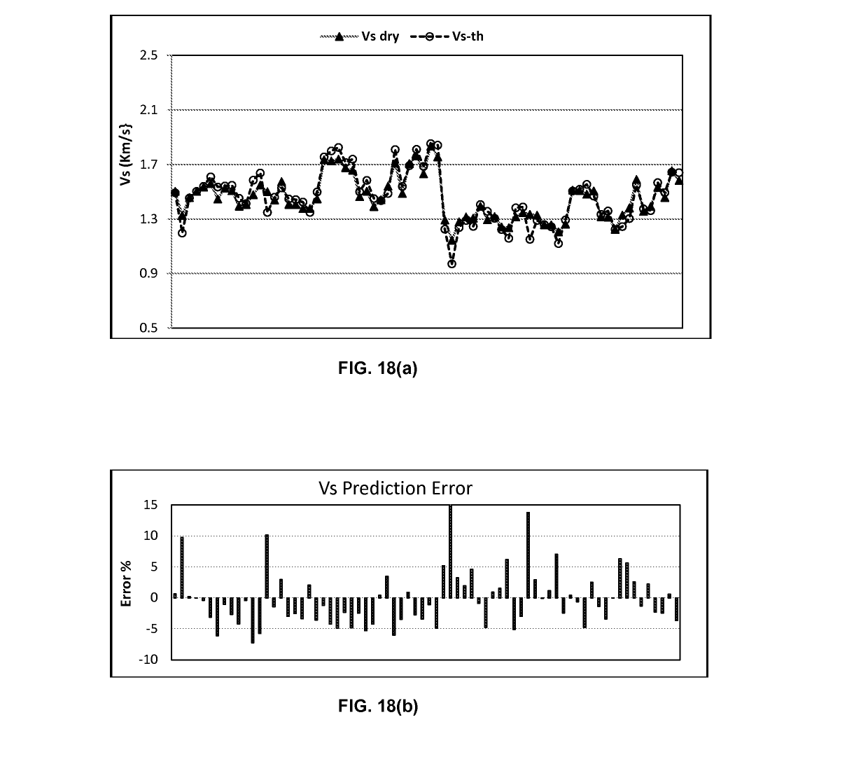

FIG. 18 shows the validity of workflow 300 shown in FIG. 3, where shear is predicted using compressional dry velocities in core samples made of Quartz-Feldspar-Mica-Clay (Blangy et al., 1993). The shear prediction works within 5% uncertainty.

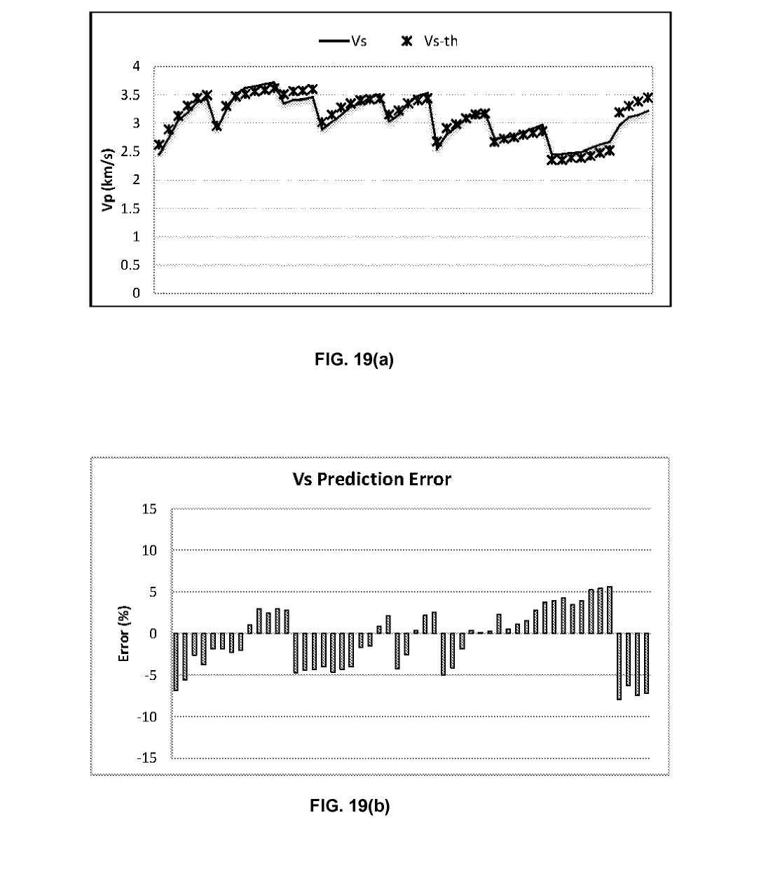

FIG. 19 shows the similar prediction of Vs from Vp in shaly sand core data (Gomez 2010), while validating workflow 300 shown in FIG. 3. Shear is predicted within 5% uncertainty.

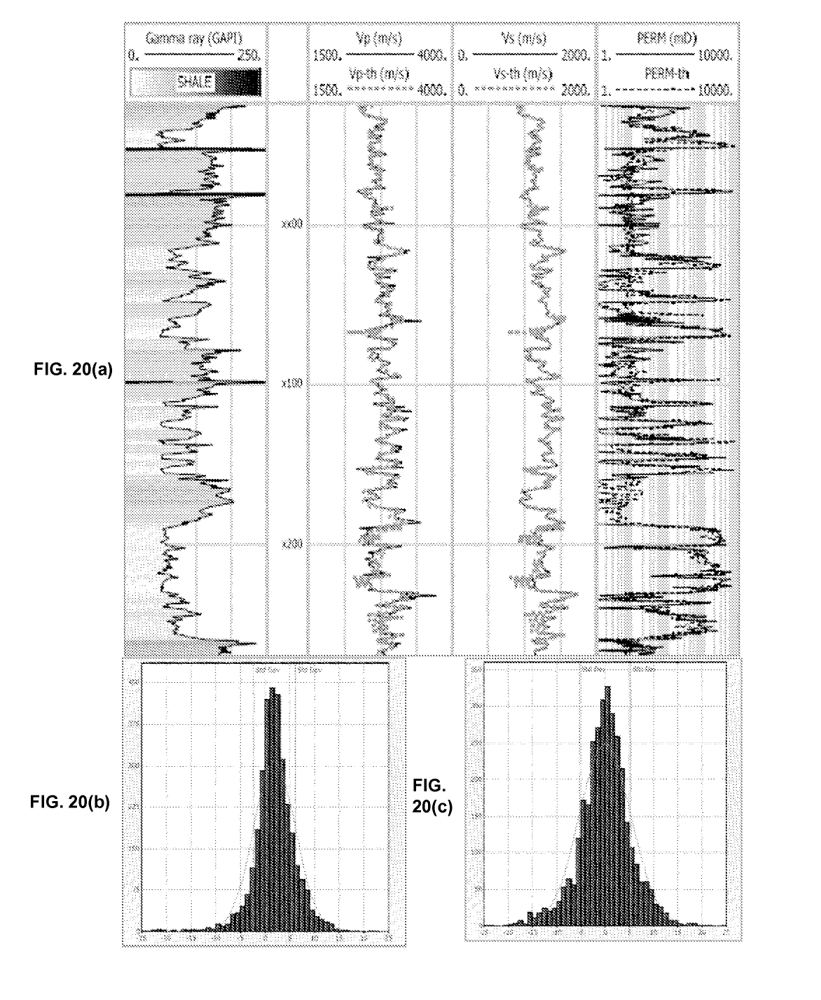

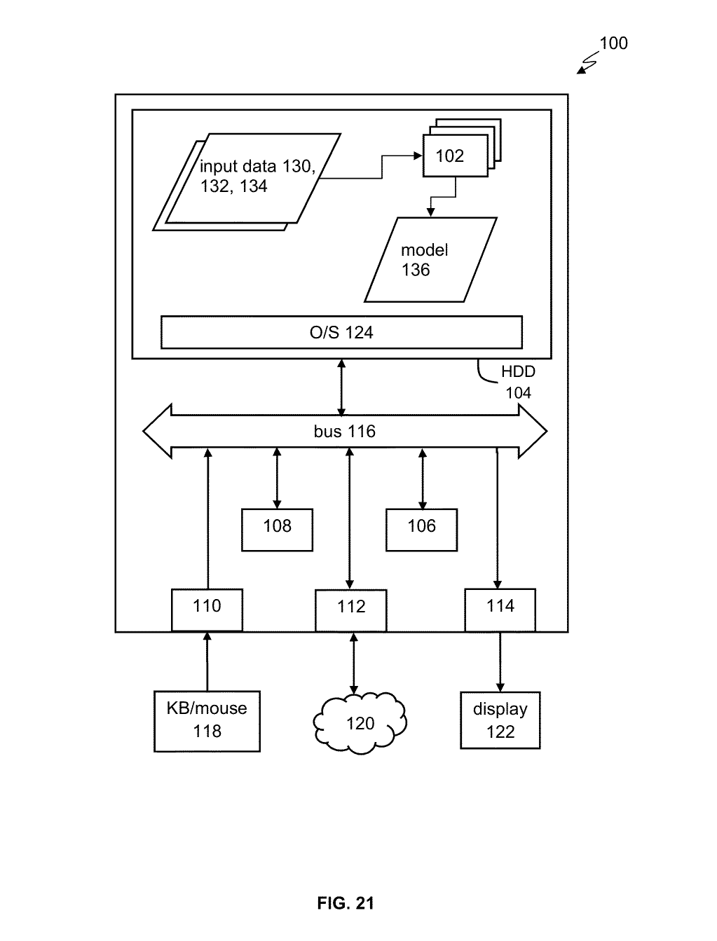

FIG. 20(a) shows the validity of workflows 500 and 600 shown in FIG. 5 and FIG. 6 using log data. In shaly sand well wet shear velocities are predicted at logging frequency, using wet compressional velocities from Sonic log. Similarly wet compressional velocities are predicted at logging frequency, using wet shear velocities from Sonic log. Predicted logs are overlaid with actual velocity logs and show excellent prediction (FIG. 20(a), Track-2 & 3). Permeability is simultaneously predicted from workflow 600. Predicted and core-calibrated permeability are overlain (Track-4) and show excellent quantitative match.

The uncertainty analysis for velocity prediction shown in FIG. 20(a) is demonstrated in FIG. 20(b) and FIG. 20(c). It is shown that the cumulative uncertainty of P-to-S velocity prediction and S-to-P velocity prediction remains within −5% (P10) and +5% (P90) errors.

In the described embodiments, the system for rock physics modelling may be a standard computer system such as an Intel IA-32 based computer system 100, as shown in FIG. 21, and the associated rock physics modelling processes 300, 400, 500, 600 executed by the system 100 are implemented in the form of programming instructions of one or more software modules or components 102 (such as a rock physics modelling component) stored on tangible and non-volatile (e.g., solid-state or hard disk) storage 104 associated with the computer system 100, as shown in FIG. 21. In one example, the software modules or components 102 may be compiled binaries generated from code of a programming language such as Fortran 77. However, it will be apparent that the processes could alternatively be implemented, either in part or in their entirety, in the form of one or more dedicated hardware components, such as application-specific integrated circuits (ASICs), and/or in the form of configuration data for configurable hardware components such as field programmable gate arrays (FPGAs), for example.

As shown in FIG. 21, the system 100 includes standard computer components, including random access memory (RAM) 106, at least one processor 108, and external interfaces 110, 112, 114, all interconnected by a bus 116. The external interfaces include universal serial bus (USB) interfaces 110, at least one of which is connected to a keyboard 118 and pointing device such as a mouse, and a network interface connector (NIC) 112 which connects the system 100 to a communications network 120 such as the Internet.

The system 100 also includes a display adapter 114, which is connected to a display device such as an LCD panel display 122, and a number of standard software modules, including an operating system 124 such as Linux or Microsoft Windows. The system 100 may include structured query language (SQL) support (not shown) such as MySQL, available from http://www.mysql.com, which allows data to be stored in and retrieved from an SQL database (not shown), including data representing the input petrophysical parameters and core or log data, and the outputs of the modelling processes 300, 400, 500, 600. In some embodiments, the input data 130, 132, 134 and the output data 136 representing the rock physics models output by the processes 300, 400, 500 and 600 may be stored in flat file format or any suitable binary format on storage 104 of the system 100.

A variety of other variations and modifications which do not depart from the scope of the invention will be evident to persons of ordinary skill in the art from the disclosure herein. The following claims are intended to cover the specific embodiments set forth herein as well as such variations, modifications, and equivalents.

### REFERENCES

1. Alam M. M., Fabricius I. L. & Prasad M., 2011, Permeability prediction in chalks, AAPG Bulletin, v. 95, no. 11, 1991-2014
2. Baechle G. T, Colpaert A., Eberli G. P. & Weger R. J., 2007, Modeling velocity in carbonates using a dual porosity DEM model, SEG/San Antonio Annual Meeting
3. Berrymann J. G., Pride S. R., & Wang H. F., 2002, A differential scheme for elastic properties of rocks with dry and saturated cracks, Geophy. J. Int., 151, 597-611
4. Best A. I, McCann C. & Sothcot J., 1994, The relationships between the velocities, attenuations and petrophysical properties of reservoir sedimentary rocks, Geophysical Prospecting, 1994, 42, 151-178
5. Biot, M. A., 1956. Theory of propagation of elastic waves in a fluid saturated porous solid: I. Low frequency range and II. Higher frequency range. J. Acoust. Soc. Am. 28, 168-191
6. Blangy, J. P., 1992, Integrated seismic lithologic interpretation: The petrophysical basis: Ph. D. thesis, Stanford Univ.
7. Blangy J. P., Strandenes S., Moos D., & Nur A., 1993, Ultrasonic velocities in sands revisited, Geophysics, v. 58, no. 3, 344-356
8. Dvorkin, J & Nur, A., 1993, Dynamic poroelasticity: A unified model with the squirt and the Biot mechanisms, Geophysics, v. 58, no. 4, 524-533
9. Gassmann, F., 1951, Über die Elastizität poröser Medien: Vierteljahrsschriftder Naturforschenden Gesselschaft in Zürich, 96, 1-23
10. Geertsma. J. & Smit, D. C., 1961, Some aspects of elastic wave propagation in fluid-saturated porous solids: Geophysics, v. 26, 169-181
11. Gomez C. T., Dvorrkin J. & Vanorio T., 2010, Laboratory measurements of porosity, permeability, resistivity, and velocity on Fontainebleau sandstones, 2009, Geophysics, v. 75, no. 6, 191-204
12. Han De-hua, 1986, Effects of porosity and clay content on acoustic properties of sandstone and unconsolidated sediments, PhD. Thesis, Stanford Univ.
13. Hill R., 1963, Elastic properties of reinforced solids: some theoretical principles, J. Mech. Phys. Solids, v. 11, 357-372
14. Keys R. G. & Xu S., 2002, An approximation for the Xu-White theory, Geophysics, 67, 1406-1414
15. Khaksar A., Griffiths C. M. & McCann C., 1999, Compressional- and shear-wave velocities as a function of confining stress in dry sandstones, Geophysical Prospecting, 47, 487-508
16. Khazanehdari J, & McCann C, 2005, Acoustic and petrophysical relationships in low-shale sandstone reservoir rocks Geophysical Prospecting, 2005, 53, 447-461
17. Klimentos T., 1991, The effects of porosity-permeability-clay content on the velocity of Compressional waves, Geophysics, v. 56 no. 12, 1930-1939
18. Latief F. D. E, & Fauzi U., 2012, Kozeny-Carman and empirical formula for permeability of computer rock models, International J. of Rock Mechanics & Mining Sciences, 50, 117-123
19. Marion, D., A. Nur, H. Yin, and D. Han, 1992, Compressional velocity and porosity in sand-clay mixtures, Geophysics, v. 57, 554-563
20. Markov M., Kazatchenko E., Mousatov A., & Pervago E, 2013, Novel approach for simulating the elastic properties of porous rocks including the critical porosity phenomena, Geophysics, v. 78, no. 4, L37-L44
21. Mukerji T., Berryman J., Mavko G., Berge P., 1995, Differential Effective Medium Modeling of Rock Elastic Moduli with Critical Porosity Constraints, Geophysical Research Letters, v. 22, issue 5, 555-558
22. Norris A. N., 1985, A differential scheme for the effective moduli of composites, Mech. Materials, 4, 1-16
23. Stoll R. D., 1977, Acoustic waves in ocean sediments, Geophysics. vol. 42 no. 4, 715-725
24. Xu S. & White E. E., 1995, A new velocity model for clay-sand mixtures, Geophysical Prospecting, 43, 91-118
25. Zhang J. J. & Bentley L. R., 2000, Change of elastic moduli of dry sandstone with effective pressure, SEG Annual Meeting

1. A computer-implemented method of generating a percolated rock physics model with interacting pore scheme, the method comprising:
(i) obtaining input data relating to observed porosity values, corresponding observed compressional velocity or shear velocity values, and relative proportions of mineral components of a composite matrix comprising a host material;
(ii) for each combination of observed porosity and observed velocity, iteratively, using at least one processor: incrementing a pore aspect ratio; determining an initial dry frame compressional modulus and an initial dry frame shear modulus using the observed porosity, the observed velocity and the pore aspect ratio; modifying the initial dry frame compressional modulus using a compressional percolation function and modifying the initial dry frame shear modulus using a shear percolation function; computing a velocity from either the modified shear modulus or the modified compressional modulus; and continuing to iterate until the computed velocity matches the observed velocity within a predefined error;
whereby respective modified compressional modulus, modified shear modulus and pore aspect ratio values after a last one of said iterations represent mappings from porosity and velocity to compressional modulus, shear modulus and pore aspect ratio in the rock physics model.

2. A method according to claim 1, wherein the initial dry frame compressional modulus and the initial dry frame shear modulus are determined by a DEM process using only one of the shear velocity and compressional velocity.

3. A method according to claim 1, wherein the compressional percolation function is of the form
$$P ( p ) = [ 1 - {( \frac{φ - {φ}_{th} ( p )}{{φ}_{c} - {φ}_{th} ( p )} )}^{b} ] ,$$
where φ is the porosity, φₜₕ(p) is the compressional percolation threshold, φ_{c} is the critical porosity, and b is a constant.

4. A method according to claim 1, wherein the shear percolation function is of the form
$$P ( s ) = 1 - a ( \frac{φ}{{φ}_{c}} ) [ \frac{exp ( φ / {φ}_{c} ) + exp ( - φ / {φ}_{c} )}{2} - 1 ] ,$$
where φ is the porosity, φ_{c} is the critical porosity, and a is a constant.

5. A method according to claim 1, wherein the compressional percolation threshold is different to the shear percolation threshold.

6. A method according to claim 1, further comprising determining a permeability value during each iteration over the pore aspect ratio, whereby respective permeability values after the last iteration over the pore aspect ratio represent a mapping from porosity and velocity to permeability in the rock physics model.

7. A method according to claim 6, wherein the permeability value is determined according to
$$k = A ( \frac{C ( φ ) {φ}^{p}}{{S}_{vp}^{2}} ) φ ,$$
where C(φ) is a pore connectivity function, Sᵥₚ is the specific pore surface area iteratively computed during pore inclusion for each aspect ratio iteration, and A & p are constants.

8. A method according to claim 6, wherein the pore connectivity-function C(φ) is of the form
$$C ( φ ) = [ \frac{1}{1 + c {φ}^{- d}} ] ,$$
where φ is porosity, and c and d are constants.

9. A method according to claim 6, wherein specific pore surface area (pore surface area per unit pore volume) of ellipsoidal inclusion is determined according to
$${S}_{vp}^{i} = {( {10}^{- 6} α )}^{2 / 3} {( \frac{9 π}{2} )}^{1 / 3} ( 1 + {Sin}^{- 1} ( \sqrt{1 - {α}^{2}} ) / α \sqrt{1 - {α}^{2}} )$$
where α is aspect ratio of ellipsoidal inclusion of infinitesimal volume Φᵢ, such that infinitesimal inclusion volume is 10⁻⁶ v/v.

10. A method according to claim 7, wherein total specific pore surface area (pore surface area per unit pore volume) for a rock with porosity Φ and considered with pores of effective aspect ratio α is determined within the inclusion iteration process according to
$${S}_{vp} = {\sum }_{φ i}^{φ} {S}_{vp}^{i}$$

11. A method according to claim 5, wherein the observed shear velocities are log shear velocities; and wherein the method further comprises, during each iteration, determining a wet shear velocity and a wet compressional velocity using the permeability value; whereby respective wet shear velocities and wet compressional velocities after the last iteration over the pore aspect ratio represent mappings from porosity and velocity to wet shear velocity and wet compressional velocity in the rock physics model.

12. A method according to claim 11, wherein the wet compressional velocity is determined during each iteration using Gassmann's algorithm with a small correction factor to replace shear dispersion module for simulation.

13. A method according to claim 5, wherein the observed compressional velocities are log compressional velocities; and wherein the method further comprises, during each iteration, determining a wet shear velocity and a wet compressional velocity using the permeability value; whereby respective wet shear velocities and wet compressional velocities after the last iteration over the pore aspect ratio represent mappings from porosity and velocity to wet shear velocity and wet compressional velocity in the rock physics model.

14. A method of predicting petrophysical quantities from porosity and corresponding shear velocity data or compressional velocity data, comprising:
generating a rock physics model according to claim 1; and
mapping the porosity and shear velocity or compressional velocity to one or more of: compressional modulus, shear modulus, pore aspect ratio, permeability, wet shear velocity and wet compressional velocity using the rock physics model.

15. A system for generating a percolated rock physics model, comprising at least one processor, and a non-volatile storage medium having stored thereon a rock physics component which is configured to cause the at least one processor to carry out the method according to claim 1.

16. A method of predicting an effective aspect ratio from porosity and velocity data, which may have microscopic imprint for rock classification and faces discrimination.

17. A system for predicting petrophysical quantities from porosity and corresponding shear velocity data or compressional velocity data, comprising at least one processor, and a non-volatile storage medium having stored thereon a rock physics component which is configured to cause the at least one processor to carry out the method according to claim 14.
